(19) United States
(12) Patent Application Publication
(10) Pub. No.: US 2014/0106131 A1
(43) Pub. Date: Apr. 17, 2014

(54) TRANSPARENT CONDUCTIVE FILM AND USE THEREOF

(71) Applicant: Nitto Denko Corporation, Osaka (JP)

(72) Inventors: Kazuhiro Ikai, Ibaraki-shi (JP); Katsunori Takada, Ibaraki-shi (JP); Hiroki Kuramoto, Ibaraki-shi (JP); Hiroyuki Takao, Osaka (JP); Naoki Tsuno, Ibaraki (JP)

(73) Assignee: NITTO DENKO CORPORATION, Osaka (JP)

(21) Appl. No.: 14/048,498

(22) Filed: Oct. 8, 2013

(30) Foreign Application Priority Data
Oct. 12, 2012 (JP) 2012-227227

(51) Int. Cl. G06F 3/041; G02B 5/20

(52) U.S. Cl. CPC G06F 3/041; G02B 5/20
USPC 428/172

(57) ABSTRACT

A transparent conductive film for a display element which includes a black matrix having a polygonal opening and has a definition of 150 ppi or more, the transparent conductive film including: a transparent polymer base material; a transparent conductive layer; and a cured resin layer, wherein an outermost surface layer on a side where the cured resin layer is formed has a flat portion and a protrusion portion on the surface, a height of the protrusion portion is larger than 10 nm above the flat portion, and a maximum diameter of a cross-sectional shape formed by intersection of a surface parallel to the flat portion and the protrusion portion at a distance of 10 nm from the flat portion is smaller than a minimum value of distances between two non-adjacent sides of the opening of the black matrix.

### BACKGROUND OF THE INVENTION

1. Field of the Invention

The present invention relates to a transparent conductive film and a use thereof.

2. Description of the Related Art

Transparent conductive films, in which a transparent conductive thin film is formed on a transparent polymer base material, are widely used for transparent electrodes for solar cells, inorganic EL elements and organic EL elements, electromagnetic wave shielding materials, touch panels and so on. Particularly, in recent years, the mounting rate of touch panels on mobile phones, portable game machines, electronic instruments called a tablet PC, and so on has been rising, leading to a rapid increase in demand for transparent conductive films.

As transparent conductive films that are used for touch panels and so on, those in which a conductive metal oxide film of an indium/tin composite oxide (ITO) or the like is formed on a flexible transparent polymer base material such as polyethylene terephthalate film are widely used. In these transparent conductive films, a cured resin layer (hard coat layer) may be formed on the base material for the purpose of ensuring that scratches originally existing in the transparent polymer base material are not visually recognized, or preventing scratches which may be generated in the production process.

Since the cured resin layer generally has high surface smoothness, a transparent conductive film in which a cured resin layer is provided on the surface of a base material has such a problem that it lacks slidability and blocking resistance, and is poor in handling property. When a film is produced or processed, a wound body is often formed by winding a long sheet in a roll shape in view of productivity and handling property, but a film that lacks slidability tends to be scratched at the film surface when the film is conveyed in the form of a roll or wound as a wound body, and tends to be poor in winding property when the film is wound in a roll shape. When a film poor in blocking resistance is wound in a roll shape, blocking tends to occur during storage/conveyance of the wound body.

For solving the problems described above, a technique has been proposed in which a fine unevenness is formed on the surface of a transparent plastic film to improve slidability and blocking resistance (JP-A-2003-45234).

However, when a fine unevenness on a plastic film is formed as described in JP-A-2003-45234, a failure in appearance may occur such as deterioration of transparency of a transparent conductive film due to light scattering by the unevenness.

On the other hand, a method is also conceivable in which by adding a relatively large particles (e.g. particles larger in size than the thickness of a cured resin layer) to the cured resin layer to form a protrusion, blocking resistance is secured with a small added amount while transparency is maintained by taking advantage of the small added amount.

However, it has been found that when a transparent conductive film using particles as described above is incorporated into a liquid crystal display or the like, the definition of which has been increasingly enhanced in recent years, glare may occur to deteriorate the appearance.

In view of the above-described situations, an object of the present invention is to provide a transparent conductive film having good transparency and antiglare performance in addition to blocking resistance, a display element using the transparent conductive film, and an image display device including the display element.

### SUMMARY OF THE INVENTION

The present inventors have conducted intensive studies for solving the aforementioned problems, and resultantly found that a transparent conductive film, which includes an outermost surface layer having a protrusion portion having a specific size compatible with a high-definition display, can achieve the above-mentioned object, leading to the present invention.

That is, the present invention is a transparent conductive film for a display element which includes a black matrix having a polygonal opening and has a definition of 150 ppi or more, the transparent conductive film including: a transparent polymer base material; a transparent conductive layer provided on a first main surface side of the transparent polymer base material; and a cured resin layer provided at least one of: between the transparent polymer base material and the transparent conductive layer; and on a second main surface opposite to the first main surface of the transparent polymer base material, wherein a flat portion and a protrusion portion are formed on a surface of an outermost surface layer on a side where the cured resin layer is formed, a height of the protrusion portion is larger than 10 nm above the flat portion, and a maximum diameter of a cross-sectional shape formed by intersection of a surface parallel to the flat portion and the protrusion portion at a distance of 10 nm from the flat portion is smaller than a minimum value of distances between two non-adjacent sides of the opening of the black matrix.

The transparent conductive film can exhibit excellent blocking resistance owing to the protrusion portion at the surface of the outermost surface layer. Since the transparent conductive film is excellent in film winding property, a wound body can be easily prepared by winding a long sheet in a roll shape, and therefore the transparent conductive film is excellent in workability when used for subsequent formation of a touch panel, or the like, and can also contribute to reduction of costs and wastes. Since the flat portion and the protrusion portion are made to coexist rather than forming a fine unevenness over the entire surface of the cured resin layer, the protrusion portion is formed in the flat portion even at the outermost surface layer, and as a result, high transparency of the transparent conductive film can be maintained. Further, since a maximum diameter of a cross-sectional shape of the foot (region at a height of 10 nm above the flat portion) of the protrusion portion of the outermost surface layer is smaller than a minimum value of distances between two non-adjacent sides of the opening of the black matrix of the display element, the transparent conductive film can also cope with definition enhancement of the display element by preventing glare even when incorporated into a high-definition display element of 150 ppi or more.

Preferably, the cured resin layer has a base flat portion and a base protrusion portion on the surface, and the flat portion of the outermost surface layer is formed resulting from the base flat portion, and the protrusion portion is formed resulting from the base protrusion portion. By providing a base flat portion and a base protrusion portion on a cured resin layer which is relatively easily increased in thickness and subjected to surface processing, a flat portion and a protrusion portion, which follow the base flat portion and the base protrusion portion, respectively, can be easily given to the outermost surface layer of the transparent conductive film as well.

Preferably, the cured resin layer contains particles, and the base protrusion portion is formed resulting from the particles. Consequently, a base protrusion portion can be formed efficiently and easily and conveniently, so that a protrusion portion can be formed at the outermost surface layer, and also improvement of transparency (haze reduction) can be easily achieved.

By ensuring that a thickness of the base flat portion of the cured resin layer is smaller than a mode diameter of the particles, the haze can be reduced to further improve transparency.

In the transparent conductive film, the cured resin layer may be provided between the transparent polymer base material and the transparent conductive layer, and a refractive index adjusting layer may be provided between the cured resin layer and the transparent conductive layer.

The haze of the transparent conductive film is preferably 5% or less. Consequently, high transparency can be exhibited to secure good visibility.

The transparent conductive film may further include a transparent conductive layer provided on the second main surface side opposite to the first main surface side of the transparent polymer base material.

The transparent conductive film may be used in the form of a transparent conductive film wound body formed by obtaining the transparent conductive film in a long sheet shape and winding the sheet in a roll shape.

The present invention also includes a touch panel including the transparent conductive film, a display element including the transparent conductive film and having a definition of 150 ppi or more, and an image display device in which the display element having a definition of 150 ppi or more and the touch panel are laminated. The transparent conductive film can cope with a display element or the like, the definition of which is increasingly enhanced, so that clearer images can be acquired.

### BRIEF DESCRIPTION OF THE DRAWINGS

FIG. 1 is a schematic sectional view of a transparent conductive film according to one embodiment of the present invention;

FIG. 2 is a schematic plan view of a black matrix in a display element;

FIG. 3A is an enlarged plan view schematically showing one example of an opening of a black matrix;

FIG. 3B is an enlarged plan view schematically showing another example of an opening of a black matrix;

FIG. 4A is a schematic plan view schematically showing a relationship between a maximum diameter of a cross-sectional shape of a protrusion portion of an outermost surface layer and a minimum value of distances between two non-adjacent sides of an opening of a black matrix;

FIG. 4B is a sectional view schematically showing a relationship between a maximum diameter of a cross-sectional shape of a protrusion portion of an outermost surface layer and a minimum value of distances between two non-adjacent sides of an opening of a black matrix; and

FIG. 5 is a schematic view showing one example of a maximum diameter of a cross-sectional shape of a protrusion portion of an outermost surface layer.

### DETAILED DESCRIPTION OF THE PREFERRED EMBODIMENTS

One embodiment of the present invention will be described below with reference to the drawings. FIG. 1 is a sectional view schematically showing one embodiment of a transparent conductive film of the present invention. In a transparent conductive film 10, a transparent conductive layer 3 is formed on the side of a first main surface 1a which is one main surface of a transparent polymer base material 1, and cured resin layers 2a and 2b (hereinafter, collectively referred to as a “cured resin layer 2” in some cases) containing particles 5 are formed, respectively, between the transparent polymer base material 1 and the transparent conductive layer 3 and on the side of a second main surface 1b which is the other main surface of the transparent polymer base material 1. Further, a refractive index adjusting layer 4 is formed between the cured resin layer 2a and the transparent conductive layer 3. In the transparent conductive film 10, cured resin layers 2a and 2b are formed on both surfaces of the transparent polymer base material 1, so that the transparent conductive layer 3 is the outermost surface layer on the first main surface 1a side of the transparent polymer base material 1, and the cured resin layer 2b is the outermost surface layer on the second main surface 1b side.

The cured resin layer 2a has a base flat portion 21 and a base protrusion portion 22 on its surface. In the transparent conductive film 10, the thickness of each of the refractive index adjusting layer 4 and the transparent conductive layer 3 is made small as compared to the thickness of the cured resin layer 2a, and therefore the refractive index adjusting layer 4 and the transparent conductive layer 3 are laminated so as to follow the surface of the cured resin layer 2a. Consequently, the transparent conductive layer 3 which is the outermost surface layer has a flat portion 31 and a protrusion portion 32 resulting from the base flat portion 21 and the base protrusion portion 22, respectively, of the cured resin layer 2a. Similarly, the cured resin layer 2b also has a flat portion and a protrusion portion.

The height of the protrusion portion 32 of the transparent conductive layer 3 is larger than 10 nm with respect to the flat portion 21, but is preferably 100 nm or higher and 3 μm or lower, more preferably 200 nm or higher and 2 μm or lower, further preferably 300 nm or higher and 1.5 μm or lower. When the height of the protrusion portion 32 falls within the above-described range, blocking resistance is satisfied, and glare can be sufficiently reduced and an increase in haze can be sufficiently suppressed.

In the transparent conductive film 10, a maximum diameter at or near the foot of the protrusion portion of the outermost surface layer on a side where the cured resin layer 2 is formed (transparent conductive layer 3 and cured resin layer 2b in this embodiment) and a minimum value of distances between two non-adjacent sides of an opening of a black matrix of a display element satisfy a specific relationship. This configuration will be described below.

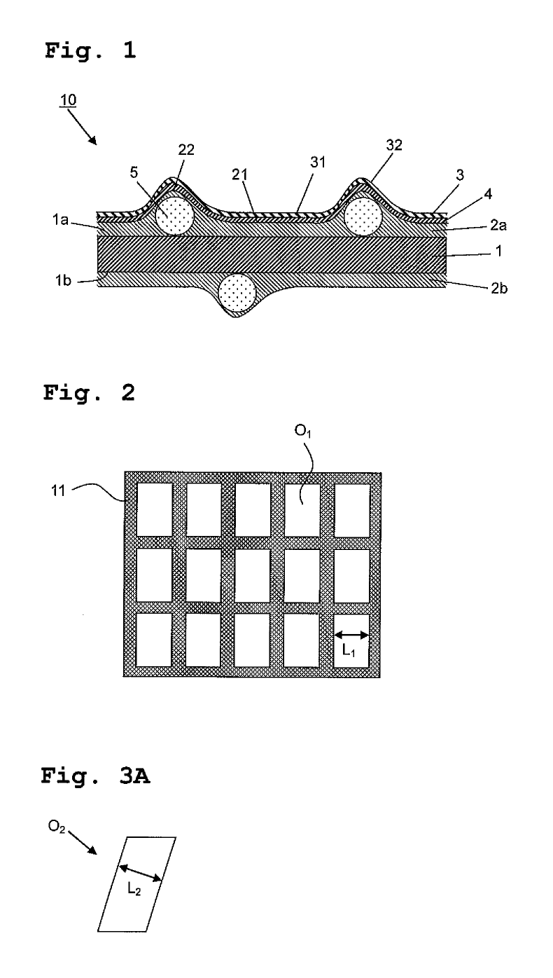

The black matrix 11 is used, for example, as a member which controls transmission of light of R (red), G (green) and B (blue) in association with each pixel (sub pixel) of a color filter in a liquid crystal display element or the like. The black matrix 11 is a lattice-like member with a rectangular opening O₁ formed in a matrix shape as shown exemplarily in FIG. 2. The pixel density of the display element is defined by the size of the opening O₁. The opening O₁ has a rectangular shape formed by two pairs of two parallel opposite sides. Therefore, the opening O₁ has shorter sides and longer sides as two non-adjacent sides. In the opening O₁, among distances between shorter sides and between longer sides, the distance between longer sides is shorter, and therefore the minimum value of distances between two non-adjacent sides is a distance L₁ between longer sides.

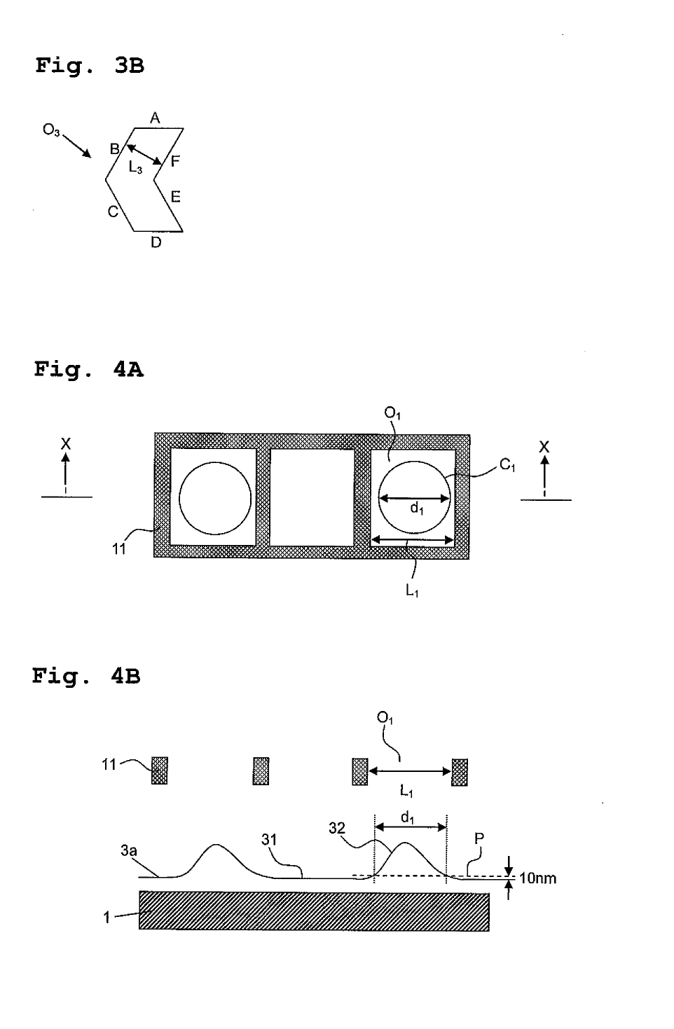

FIGS. 3A and 3B are plan views each showing another form of the opening. The shape of an opening O₂ shown in FIG. 3A is parallelogram in a plan view, and the minimum value of distances between two non-adjacent sides is a distance L₂ between longer sides. The shape of an opening O₃ shown in FIG. 3B is such a shape that two parallelograms (congruent with each other in FIG. 3B) in a plan view are combined so as to form a V shape as a whole by contacting each other at their shorter sides. Here, the opening O₃ is formed by three pairs of two parallel opposite sides. In this case, theoretically, there exist six pairs as combinations of two non-adjacent sides (six pairs, i.e. A-C, A-D, A-E, B-D, B-E and B-F when A to F are assigned to the sides, respectively, and duplicates are removed in consideration of symmetry as shown in FIG. 3B) and among them, a distance L₃ between B and F corresponds to the minimum value of distances between two non-adjacent sides. For other forms of openings, the minimum value of distances between two non-adjacent sides can be determined based on a similar approach.

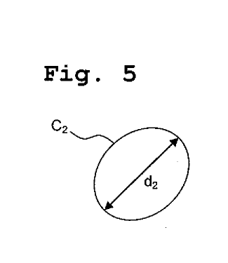

FIGS. 4A and 4B are schematic views where when a transparent conductive film and a display element are laminated, only a black matrix forming the display element is extracted, and the black matrix and the transparent conductive film are shown as a laminate. FIG. 4A is a schematic view of the laminated body in a plan view from the black matrix 11 side, and FIG. 4B is an X-X line sectional view of FIG. 4A. In the transparent conductive film 10, a maximum diameter d₁ of a cross-sectional shape C₁ formed by intersection of a surface P parallel to the flat portion 31 of the transparent conductive layer 3 as an outermost surface layer and the protrusion portion 32 at a distance of 10 nm from the flat portion 31 is smaller than a minimum value L₁ of distances between two non-adjacent sides (between longer sides here) in the opening O₁ of the black matrix 11 of the display element. For convenience of explanation, in FIG. 4A, the whole of the protrusion portion 32 is not shown, but only the cross-sectional shape C₁ is shown inside the opening O₁ and in FIG. 4B, only the transparent polymer base material 1 and an contour 3a of the surface of the transparent conductive layer 3 on the first main surface 1a side of the transparent polymer base material 1 are shown among constituent elements of the transparent conductive film in FIG. 1. Of course, the cured resin layer 2b is also provided as an outermost surface layer on the second main surface 1b side of the transparent polymer base material, and therefore a relationship similar to that described above is satisfied for the protrusion portion in the cured resin layer 2b.

A maximum diameter of the cross-sectional shape of the foot of the protrusion portion should be smaller than a minimum value of distances between two non-adjacent sides of the opening of the black matrix, and the maximum diameter is preferably 10 to 95%, more preferably 10 to 80% of the minimum value of distances between two non-adjacent sides.

In the transparent conductive film 10, the size at or near the foot of the protrusion portion of the outermost surface layer and the opening size of the opening of the black matrix have a specific relationship, and therefore glare can be prevented even in combination with a high-definition display element while blocking resistance is imparted.

In FIGS. 4A and 4B, the transparent conductive layer 3 and the black matrix 11 are laminated so as to face each other, but the lamination form is not limited thereto, and may be such a lamination form that the cured resin layer 2b on the second main surface 1b side of the transparent polymer base material 1 and the black matrix 11 face each other. In any lamination form, a maximum diameter of a cross-sectional shape of an outermost surface layer is smaller than a minimum value of distances between two non-adjacent sides of an opening of a black matrix.

FIG. 5 is a schematic view showing another form of cross-sectional shape formed by intersection of a surface parallel to the flat portion and the protrusion portion. The cross-sectional shape C₁ in FIG. 4A is circular, whereas a cross-sectional shape C₂ in FIG. 5 is elliptic. A maximum diameter d₂ in this case is equal to the longer diameter of the ellipse.

The haze of the transparent conductive film is not particularly limited as long as required transparency can be secured, but the haze is preferably 5% or less, more preferably 4% or less, further preferably 3% or less. The lower limit of the haze is preferably 0%, but is often 0.3% or more in general, due to presence of a protrusion portion of an outermost surface layer, or the like.

### <Transparent Polymer Base Material>

The transparent polymer base material 1 is not particularly limited, and various kinds of plastic films having transparency are used. Examples of the material thereof include a polyester-based resin, an acetate-based resin, a polyether sulfone-based resin, a polycarbonate-based resin, a polyamide-based resin, a polyimide-based resin, a polyolefin-based resin, a polycycloolefin-based resin such as a polynorbornene-based resin, a (meth)acryl-based resin, a polyvinyl chloride-based resin, a polyvinylidene chloride-based resin, a polystyrene-based resin, a polyvinyl alcohol-based resin, a polyarylate-based resin and a polyphenylene sulfide-based resin. Among them especially preferable are a polyester-based resin, a polycarbonate-based resin and a polyolefin-based resin.

The thickness of the transparent polymer base material 1 is preferably in a range of 2 to 200 μm, more preferably in a range of 20 to 180 μm. If the thickness of the transparent polymer base material 1 is less than 2 μm, the mechanical strength of the transparent polymer base material 1 may become insufficient, thus making it difficult to perform an operation to continuously form the transparent conductive layer 4 with the film base material formed in a roll shape. On the other hand, if the thickness is more than 200 μm, the scratch resistance of the transparent conductive layer 4 and dotting property as intended for use in a touch panel may not be improved.

The surface of the transparent polymer base material 1 may be subjected beforehand to an etching treatment or a undercoating treatment such as sputtering, corona discharge, flame, ultraviolet-ray irradiation, electron-beam irradiation, chemical conversion or oxidation to improve adhesion with a cured resin layer, a transparent conductive layer and the like which are formed on the film base material. The surface of the film base may be freed from dust and cleaned by solvent cleaning or ultrasonic cleaning as necessary before the cured resin layer and the transparent conductive layer are formed.

### <Cured Resin Layer>

The cured resin layer 2 has, on its surface, the base flat portion 21 and the base protrusion portion 22. The base protrusion portion 22 is formed resulting from particles 5 contained in the cured resin layer 2. The height of the base protrusion portion 22 is more than 10 nm with respect to the base flat portion 22, and is preferably 100 nm or more and 3 μm or less, more preferably 200 nm or more and 2 to or less, further preferably 300 nm or more and 1.5 μm or less. By setting the height of the base protrusion portion 22 to the range described above, a predetermined protrusion portion can be given to the outermost surface layer (the transparent conductive layer 3 on the first main surface 1a side and the cured resin layer 2b on the second main surface 1b side in FIG. 1). As a result, the blocking resistance of the transparent conductive film 10 is satisfied, while glare can be sufficiently reduced, and an increase in haze can be sufficiently suppressed.

The thickness of the base flat portion 21 of the cured resin layer 2 is not particularly limited, but is preferably 200 nm or more and 30 μm or less, more preferably 500 nm or more and 10 μm or less, further preferably 800 nm or more and 5 μm or less. If the thickness of the base flat portion of the cured resin layer is excessively small, precipitation of low-molecular-weight components such as an oligomer from the transparent polymer base material cannot be suppressed, so that visibility of a transparent conductive film and a touch panel using the film may be deteriorated. On the other hand, if the thickness of the base flat portion of the cured resin layer is excessively large, the transparent conductive film may be curled with the cured resin layer forming surface facing inward due to heating during crystallization of the transparent conductive layer and during assembly of the touch panel. Thus, if the thickness of the base flat portion of the cured resin layer is large, the film may have poor handling property which is not related to blocking resistance and slidability. The thickness of the base flat portion of the cured resin layer as used herein refers to an average thickness in the base flat portion of the cured resin layer.

Further, it is preferred that the thickness of the base flat portion 21 of the cured resin layer 2 is made smaller than the mode diameter of particles 5 because the haze can be reduced to further improve transparency.

The mode diameter of particles can be appropriately set in consideration of the size of the protrusion portion of the outermost surface layer, the thickness of the base flat portion 21 of the cured resin layer 2 and so on, and is not particularly limited. From the viewpoint of sufficiently imparting blocking resistance to the transparent conductive film and sufficiently suppressing an increase in haze, the mode diameter of particles is preferably 500 nm or more and 30 μm or less, more preferably 800 nm or more and 20 μm or less, more preferably 1 μm or more and 10 μm or less. The “mode diameter” as used herein refers to a particle diameter showing a maximum value in the particle distribution, and can be determined by making a measurement under predetermined conditions (Sheath liquid: ethyl acetate, measurement mode: HPF measurement, measurement method: total count) using a flow-type particle image analyzer (manufactured by Sysmex Corporation, trade name “FPIA-3000S”). Particles are diluted to 1.0% by weight with ethyl acetate, and uniformly dispersed using an ultrasonic cleaning machine, and the dispersion thus obtained is used as a measurement sample.

Particles may be either polydisperse particles or monodisperse particles, but monodisperse particles are preferred when ease of giving a protrusion portion and antiglare performance are considered. In the case of monodisperse particles, the particle diameter of particles and the mode diameter can be considered substantially identical.

The content of particles in the cured resin layer is preferably 0.01 to 5 parts by weight, more preferably 0.02 to 1 parts by weight, further preferably 0.05 to 0.5 parts by weight based on 100 parts by weight of solid content of the resin composition. If the content of particles in the cured resin layer is low, a base protrusion portion sufficient to impart blocking resistance and slidability to the surface of the cured resin layer may become hard to be formed. On the other hand, if the content of particles is excessively high, the haze of the transparent conductive film may be increased due to light scattering by particles to deteriorate visibility. Further, if the content of particles is excessively high, streaks may occur during formation of the cured resin layer (during application of a solution), leading to deterioration of visibility and nonuniformity in electrical property of the transparent conductive layer.

### (Resin Composition)

As a resin composition that forms the cured resin layer 2, one which is capable of dispersing particles, has a sufficient strength as a film after formation of the cured resin layer and has transparency can be used without particular limitation. Examples of the resin to be used include a thermosetting resin, a thermoplastic resin, an ultraviolet-ray curing-type resin, an electron-beam curing-type resin and a two-component mixing type resin, and among them, an ultraviolet-ray curing-type resin is preferred with which a film can be formed efficiently by a simple processing operation of a curing treatment by ultraviolet-ray irradiation.

Examples of the ultraviolet-ray curing-type resin include various kinds such as polyester-based, acryl-based, urethane-based, amide-based, silicone-based and epoxy-based ultraviolet-ray curing-type resins, which include ultraviolet-ray curing-type monomers, oligomers and polymers. Examples of the ultraviolet-ray curing-type resin that is preferably used include those having an ultraviolet-ray polymerizable functional group, particularly those containing an acryl-based monomer or oligomer component having 2 or more, particularly 3 to 6 such functional groups. Further, the ultraviolet-ray curing-type resin contains an ultraviolet-ray polymerization initiator.

For the resin layer forming material, additives such as a leveling agent, a thixotropy agent and an antistatic agent can be used in addition to the aforementioned materials. Use of a thixotropy agent is advantageous for formation of protruding particles in a fine unevenness-shaped surface. Examples of the thixotropy agent include silica and mica, each of which has a size of 0.1 μm or less. It is preferred that the content of these additives is normally about 15 parts or less by weight, preferably 0.01 to 15 parts by weight based on 100 parts by weight of the ultraviolet-ray curing-type resin.

### (Particles)

For particles that are contained in the cured resin layer 2, those having transparency, such as various kinds of metal oxides, glass and plastic, can be used without particular limitation. Examples thereof include inorganic particles such as silica, alumina, titanium, zirconia and calcium oxide, crosslinked or uncrosslinked organic particles formed of various kinds of polymers such as polymethyl methacrylate, polystyrene, polyurethane, acryl-based resins, acryl-styrene copolymers, benzoguanamine, melamine and polycarbonate, and silicone-based particles. One kind or two or more kinds of particles can be appropriately selected from the aforementioned particles, and used, but organic particles are preferred. As organic particles, acryl-based resins are preferred in terms of a refractive index.

### (Coating Composition)

A coating composition that is used for forming the cured resin layer includes the above-described resin, particles and solvent. To the coating composition can be added various additives as necessary. Examples of these additives include usual additives such as an antistatic agent, a plasticizer, a surfactant, an antioxidant and an ultraviolet-ray absorber.

The coating composition is prepared by mixing the above-described resin and particles with a solvent, additives, a catalyst and so on as necessary. The solvent in the coating composition is not particularly limited, and is appropriately selected in consideration of a resin used, a material of a portion as a coating ground and a method for applying the composition. Specific examples of the solvent include aromatic solvents such as toluene and xylene; ketone-based solvents such as methyl ethyl ketone, acetone, methyl isobutyl ketone and cyclohexanone; ether-based solvents such as diethyl ether, isopropyl ether, tetrahydrofuran, dioxane, ethylene glycol dimethyl ether, ethylene glycol diethyl ether, diethylene glycol dimethyl ether, diethylene glycol diethyl ether, propylene glycol monomethyl ether, anisole and phenetole; ester-based solvents such as ethyl acetate, butyl acetate, isopropyl acetate and ethylene glycol diacetate; amide-based solvents such as dimethyl formamide, diethyl formamide and N-methylpyrrolidone; cellosolve-based solvents such as methyl cellosolve, ethyl cellosolve and butyl cellosolve; alcohol-based solvents such as methanol, ethanol and propanol; and halogen-based solvents such as dichloromethane and chloroform. These solvents may be used alone, or used in combination two or more thereof. Among these solvents, ester-base solvents, ether-based solvents, alcohol-based solvents and ketone-based solvents are preferably used.

In the coating composition, preferably particles are dispersed in a solution. As a method for dispersing particles in a solution, various known methods can be employed such as a method in which particles are added to a resin composition solution, and the mixture is mixed, and a method in which particles dispersed in a solvent beforehand are added to a resin composition solution.

The solid concentration of the coating composition is preferably 1% by weight to 70% by weight, more preferably 2% by weight to 50% by weight, most preferably 5% by weight to 40% by weight. If the solid concentration is excessively low, variations in the base protrusion portion of the surface of the cured resin layer increase during a drying step after application, and the haze of an area of the surface of the cured resin layer, where the base protrusion portion becomes larger, may be increased. On the other hand, if the solid concentration is excessively high, contained components tend to aggregate, and as a result, the aggregation areas may become apparent to deteriorate the appearance of the transparent conductive film.

### (Application and Curing)

The cured resin layer is formed by applying the coating composition onto a base material. Application of the coating composition onto the transparent polymer base material 1 is applied for both surfaces of the base material in the case of this embodiment as in FIG. 1. The coating composition may be applied directly onto the transparent polymer base material 1, or may be applied onto an undercoat layer or the like formed on the transparent polymer base material 1.

A method for applying the coating composition can be appropriately selected according to a coating composition and a situation of an application step, and application can be performed using, for example, a dip coating method, an air knife method, a curtain coating method, a roller coating method, a wire bar coating method, a gravure coating method, a die coating method or an extrusion coating method.

The cured resin layer can be formed by curing the coating film after applying the coating composition. When the resin composition is photocurable, it is possible to cure by irradiating with light using a light source which emits light having a wavelength as needed. As light to irradiate the resin composition, for example, light with an exposure amount of 150 mJ/cm² or more, preferably light with an exposure amount of 200 mJ/cm² to 1000 mJ/cm² can be used. The wavelength of the irradiation light is not particularly limited, and for example, irradiation light having a wavelength of 380 nm or less can be used. Heating may be performed at the time of the photocuring treatment.

### <Transparent Conductive Layer>

The constituent material of the transparent conductive layer 3 is not particularly limited, and a metal oxide of at least one metal selected from the group consisting of indium, tin, zinc, gallium, antimony, titanium, silicon, zirconium, magnesium, aluminum, gold, silver, copper, palladium and tungsten is suitably used. The metal oxide may further contain metal atoms shown in the above-mentioned group as necessary. For example, indium oxide containing tin oxide (ITO), tin oxide containing antimony (ATO), and the like are preferably used.

The thickness of the transparent conductive layer 3 is not particularly limited, but is preferably 10 nm or more for forming a continuous film having such a good conductivity that its surface resistance is no higher than 1×10³Ω/□. If the thickness is excessively large, the transparency is deteriorated, and therefore the thickness is preferably 15 to 35 nm, more preferably in a range of 20 to 30 nm. If the thickness of the transparent conductive layer 3 is less than 15 nm, the electric resistance of the film surface increases, and a continuous film is hard to be formed. If the thickness of the transparent conductive layer 3 is more than 35 nm, deterioration of transparency or the like may be caused.

The method for forming the transparent conductive layer 3 is not particularly limited, and a previously known method can be employed. Specifically, for example, dry processes such as a vacuum deposition method, a sputtering method and an ion plating method can be shown as an example. An appropriate method can also be employed according to a required thickness. When the transparent conductive layer 3 is formed on the cured resin layer 2a forming surface side as shown in FIG. 1, the surface of the transparent conductive layer 3 almost maintains the shapes of the base flat portion and the base protrusion portion of the surface of the cured resin layer 2a which is a ground layer thereof if the transparent conductive layer 3 is formed by a dry process such as a sputtering method. Therefore, even when the transparent conductive layer 3 is formed on the cured resin layer 2a, blocking resistance and slidability can be suitably imparted to the surface of the transparent conductive layer 3 as well.

The transparent conductive layer 3 can be crystallized by being subjected to a heating annealing treatment (for example, under an air atmosphere at 80 to 150° C. for about 30 to 90 minutes) as necessary. When the transparent conductive layer is crystallized, the resistance of the transparent conductive layer is reduced, and also transparency and durability are improved. By ensuring that the thickness the cured resin layer 2a falls within the above-described range in the transparent conductive film 10, occurrence of curl is suppressed at the time of heating annealing treatment, leading to excellent handling property.

The transparent conductive layer 3 may be patterned by etching or the like. For example, in a transparent conductive film that is used in a capacitive touch panel or a matrix-type resistive touch panel, it is preferred that the transparent conductive layer 3 is patterned in a stripe form. When the transparent conductive layer 3 is patterned by etching, patterning by etching may become difficult if crystallization of the transparent conductive layer 3 is performed prior to the patterning. Therefore, preferably the annealing treatment of the transparent conductive layer 3 is performed after the transparent conductive layer 3 is patterned.

### <Refractive Index Adjusting Layer>

In the transparent conductive film 10 of this embodiment, the refractive index adjusting layer 4 is provided between the cured resin layer 2a and the transparent conductive layer 3 for the purpose of controlling adhesion and reflection property of the transparent conductive layer, and so on. The refractive index adjusting layer may be a single layer, or two or more layers may be provided. The refractive index adjusting layer is formed of an inorganic substance, an organic substance or a mixture of an inorganic substance and an organic substance. Examples of the material that forms the refractive index adjusting layer include inorganic substances such as NaF, Na₃AlF₆, LiF, MgF₂, CaF₂, SiO₂, LaF₃, CeF₃, Al₂O₃, TiO₂, Ta₂O₅, ZrO₂, ZnO, ZnS and SiOₓ (x is 1.5 or more and less than 2), and organic substances such as an acryl resin, an urethane resin, a melamine resin, an alkyd resin and a siloxane-based polymer. As the organic substance, in particular, it is preferred to use a thermosetting resin formed of a mixture of a melamine resin, an alkyd resin and an organic silane condensate. The refractive index adjusting layer can be formed by a coating method such as a gravure coating method or a bar coating method, a vacuum deposition method, a sputtering method or an ion plating method using the material described above.

The thickness of the refractive index adjusting layer 4 is preferably 10 nm to 200 nm, more preferably 20 nm to 150 nm, further preferably 20 nm to 130 nm. If the thickness of the refractive index adjusting layer is excessively small, a continuous film is hard to be formed. If the thickness of the refractive index adjusting layer is excessively large, transparency of the transparent conductive film may be deteriorated, or the refractive index adjusting layer may be easily cracked. When the refractive index adjusting layer is formed in a thickness on the order of nanometers as described above, the surface of the refractive index adjusting layer on the transparent conductive layer 3 side almost maintains the protrusion shape of the surface of the cured resin layer 2 which is a ground layer thereof. At the surface of the transparent conductive layer 3, the protrusion shape is maintained as well to form the protrusion portion 32, so that a transparent conductive film having blocking resistance and slidability can be formed.

The refractive index adjusting layer may have nano-fine particles having an average particle diameter of 1 nm to 500 nm. The content of nano-fine particles in the refractive index adjusting layer is preferably 0.1% by weight to 90% by weight. The average particle diameter of nano-fine particles that are used for the refractive index adjusting layer is preferably 1 nm to 500 nm as described above, more preferably 5 nm to 300 nm. The content of nano-fine particles in the refractive index adjusting layer is more preferably 10% by weight to 80% by weight, further preferably 20% by weight to 70% by weight. By including nano-fine particles in the refractive index adjusting layer, the refractive index of the refractive index adjusting layer itself can be easily adjusted.

Examples of the inorganic oxide that forms nano-fine particles include fine particles of silicon oxide (silica), hollow nano-silica, titanium oxide, aluminum oxide, zinc oxide, tin oxide, zirconium oxide and the like. Among them, fine particles of silicon oxide (silica), titanium oxide, aluminum oxide, zinc oxide, tin oxide and zirconium oxide are preferred. They may be used alone, or used in combination of two or more thereof.

### <Wound Body of Transparent Conductive Film>

The transparent conductive film 10 of this embodiment can be formed as a transparent conductive film wound body in which a long sheet is wound in a roll shape. The wound body of a long sheet of transparent conductive film can be formed by using a roll-shaped wound body of a long sheet as a transparent polymer base material and forming each of additional layers such as the aforementioned cured resin layer, transparent conductive layer and refractive index adjusting layer using a roll-to-roll method. In formation of such a wound body, a protective film (separator) including a weakly adhesive layer may be laminated to the surface of the transparent conductive film, followed by winding the film in a roll shape, but since the transparent conductive film of this embodiment has improved slidability and blocking resistance, a wound body of a long sheet of transparent conductive film can be formed without using a protective film. That is, since slidability and blocking resistance are improved, generation of scratches on the film surface at the time of handling is inhibited, and the film is excellent in winding property, so that a wound body is easily obtained by winding a long sheet in a roll shape without laminating a protective film to the surface. Thus, the transparent conductive film of this embodiment is capable of forming a wound body of a long sheet without using a protective film, and is therefore excellent in workability when used in subsequent formation of a touch panel. Further, the transparent conductive film contributes to cost reduction and waste reduction by eliminating necessity of a protective film as a process member.

### (Touch Panel)

The transparent conductive film 10 can be suitably applied to, for example, a capacitive touch panel, a resistive touch panel and the like.

When a touch panel is formed, other base materials such as glass and a polymer film can be laminated to one or both of the main surfaces of the transparent conductive film with a transparent pressure-sensitive adhesive layer interposed therebetween. For example, a laminated body can be formed in which a surface of the transparent conductive film on which the transparent conductive layer 3 is not formed is laminated to a transparent substrate with a transparent pressure-sensitive adhesive layer interposed therebetween. The transparent substrate may be composed of one substrate film, or may be a laminated body of two or more substrate films (for example, substrate films are laminated with a transparent pressure-sensitive adhesive layer interposed therebetween). A hard coat layer can also be provided on the outer surface of a transparent substrate that is laminated to the transparent conductive film.

For the pressure-sensitive adhesive layer that is used for laminating the transparent conductive film and the base material, any material can be used without particular limitation as long as it has transparency. Specifically, for example, one having as a base polymer a polymer such as an acryl-based polymer, a silicone-base polymer, a polyester, a polyurethane, a polyimide, a polyvinyl ether, a vinyl acetate/vinyl chloride copolymer, a modified polyolefin, an epoxy-based polymer, a fluorine-based polymer, or a rubber-based polymer such as natural rubber or synthetic rubber can be appropriately selected and used. Particularly, an acryl-based pressure-sensitive adhesive is preferably used in terms of being excellent in optical transparency, showing adhesive property such as moderate wettability, cohesiveness and tackiness, and also being excellent in weather resistance and heat resistance.

When the above-described transparent conductive film according to the present invention is used for formation of a touch panel, it is excellent in handling property during formation of the touch panel. Therefore, touch panels excellent in transparency and visibility can be produced with high productivity.

### <Display Element>

For example, the transparent conductive film of this embodiment can be suitably used for electrostatic charge prevention and electromagnetic wave shielding for transparent members of various kinds of display elements such as a liquid crystal display element and a solid-state imaging element, and as a liquid crystal light control glass, a transparent heater and the like. The protrusion portion of the outermost surface of the transparent conductive film of this embodiment has a specific relationship with an opening size of a black matrix included in the display element described above, and therefore a higher-definition display element can be provided.

### <Image Display Device>

An image display device of this embodiment has an image display element and the above-described touch panel. The image display element generally includes a color filter having a black matrix on the visual recognition side of an image display cell, and a polarizing plate on a side opposite to the visual recognition side. As the image display cell, a liquid crystal cell, an organic EL cell or the like can be used. By combining the touch panel according to this embodiment with various kinds of display elements, a higher-definition image display device (e.g. liquid crystal touch panel, etc.) in which glare is suppressed can be prepared.

### Other Embodiments

In the embodiment shown in FIG. 1, the transparent conductive layer 3 is provided only on one surface, i.e. the first main surface In side, of the transparent polymer base material 1, but the present invention is not limited thereto, and the transparent conductive layer 3 may also be provided on the other surface, i.e. the second main surface 1b side. In this case, when the cured resin layer 2b is formed as a ground layer as shown in FIG. 1, a flat portion and a protrusion portion are formed on the surface of the transparent conductive layer provided on the second main surface 1b side, resulting from the base flat portion and the base protrusion portion of the cured resin layer 2b.

As a method for forming a base protrusion portion of a cured resin layer, an appropriate method can be employed besides a method in which particles are dispersed and included in a cured resin layer to give a protrusion shape as in FIG. 1. Examples thereof include a method in which onto a cured resin layer is applied and added another cured resin layer, and a base protrusion portion is given to the surface of the cured resin layer by a transfer method using a mold, or the like. Further, a mention is made of a method in which the surface of a member itself on which a cured resin layer is provided is formed as a base protrusion portion by a method in which the surface of a film used for formation of the cured resin layer is subjected to a surface roughening treatment beforehand using an appropriate method such as a sand blast, an emboss roll or chemical etching to give a protrusion shape on the film surface, wherever possible. Two or more of these methods for forming a base protrusion may be combined to form a layer having a combination of base protrusion portions in different states. Among the aforementioned methods for forming a cured resin layer, a method of providing a cured resin layer in which particles are dispersed and included is preferred from the viewpoint of ease of giving a shape, suppression of an increase in haze and so on.

### EXAMPLES

The present invention will be described in detail below with Examples, but the present invention is not limited to Examples below as long as the spirit of the present invention is maintained. In examples, “part(s)” refers to “part(s) by weight” unless otherwise specified.

### Example 1

A coating composition containing a plurality of monodisperse particles with a mode diameter of 3.0 μm (manufactured by SEKISUI JUSHI Corporation, trade name “SSX105”) and a binder resin (manufactured by DIC Corporation, trade name “UNIDIC ELS-888”) and having ethyl acetate as a solvent was prepared. Next, the coating composition was applied to one surface of a long base material having a thickness of 100 μm (manufactured by ZEON CORPORATION, trade name “ZEONOR”) using a gravure coater so that the thickness after drying was 1.0 μm, and the coating film was dried by performing heating at 80° C. for 1 minute. Thereafter, a cured resin layer was formed by irradiation of an ultraviolet ray with an integrated light quantity of 250 mJ/cm² using a high-pressure mercury lamp. The added amount of particles was 0.07 parts based on 100 parts of the resin. A thickness of a base flat portion of the cured resin layer was determined from an average of thicknesses measured for five points at equal intervals in the film width direction using a spectroscopic measurement device (manufactured by Otsuka Electronics Co., Ltd., trade name “MCPD2000”).

Next, a refractive index adjusting agent (manufactured by JSR Corporation, trade name “Opstar KZ6661” was applied to the surface of the cured resin layer using a gravure coater, and the coating film was dried by performing heating at 60° C. for 1 minute. Thereafter, a refractive index adjusting layer having a thickness of 100 nm and a refractive index of 1.65 was formed by subjecting the coating film to a curing treatment by irradiation of an ultraviolet ray with an integrated light quantity of 250 mJ/cm² using a high-pressure mercury lamp. Thereafter, the long base material having the cured resin layer and the refractive index adjusting layer was introduced into a winding type sputtering device, and an indium tin oxide layer having a thickness of 27 nm as a transparent conductive layer (sputtering using a sintered body formed of 97% by weight of indium oxide and 3% by weight of tin oxide in an atmosphere of 0.4 Pa including 98% of argon gas and 2% of oxygen) and a copper layer having a thickness of 200 nm as a metal layer were sequentially deposited on the surface of the refractive index adjusting layer. At this time, the refractive index adjusting layer, transparent conductive layer and metal layer were deposited so as to follow the base flat portion and the base protrusion portion of the cured resin layer. In this way, a transparent conductive film was prepared.

### Example 2

A transparent conductive film was prepared in the same manner as in Example 1 except that monodisperse particles having a mode diameter of 2.5 μm (manufactured by NIPPON SHOKUBAI CO., LTD., trade name “Seahostar KE-P250”) were used as particles, and the added amount of the particles was 0.4 parts based on 100 parts of the resin.

### Example 3

A transparent conductive film was prepared in the same manner as in Example 1 except that monodisperse particles having a mode diameter of 1.8 μm (manufactured by Sokensha Co., Ltd., trade name “MX-180TA”) were used as particles, and the added amount of the particles was 0.2 parts based on 100 parts of the resin.

### Example 4

A transparent conductive film was prepared in the same manner as in Example 3 except that cured resin layers were formed on both surfaces of a long base material.

### Example 5

A transparent conductive film was prepared in the same manner as in Example 1 except that monodisperse particles having a mode diameter of 2.0 μm (manufactured by SEKISUI JUSHI Corporation, trade name “XX-134AA”) were used as particles, and the added amount of the particles was 0.2 parts based on 100 parts of the resin.

### Example 6

A transparent conductive film was prepared in the same manner as in Example 1 except that monodisperse particles having a mode diameter of 1.5 μm (manufactured by NIPPON SHOKUBAI CO., LTD., trade name “Seahostar KE-150”) were used as particles, and the added amount of the particles was 0.4 parts based on 100 parts of the resin.

### Example 7

A transparent conductive film was prepared in the same manner as in Example 1 except that monodisperse particles having a mode diameter of 1.3 μm (manufactured by Sokensha Co., Ltd., trade name “SX-130H”) were used as particles, and the added amount of the particles was 0.4 parts based on 100 parts of the resin.

### Example 8

A transparent conductive film was prepared in the same manner as in Example 1 except that monodisperse particles having a mode diameter of 3.5 μm (manufactured by SEKISUI JUSHI Corporation, trade name “XX-121AA”) were used as particles, the added amount of the particles was 0.1 part based on 100 parts of the resin, and the thickness of a cured resin layer after curing was 2.0 μm.

### Comparative Example 1

A transparent conductive film was prepared in the same manner as in Example 1 except that monodisperse particles having a mode diameter of 5 μm (manufactured by SEKISUI JUSHI Corporation, trade name “XX-83AA”) were used as particles, and the added amount of the particles was 0.1 part based on 100 parts of the resin.

### [Evaluation]

The evaluations described below were performed for the transparent conductive film obtained in each of Examples and Comparative Example.

### (Determination of Glare)

Evaluation samples were provided by cutting out the prepared transparent conductive film in 5 cm square. Separately, commercially available liquid crystal display devices including a black matrix, on which a rectangular opening (with a shape shown in FIG. 2) having the value shown in Table 1 as a minimum value of distances between two non-adjacent sides, were each provided, and placed on a horizontal table. Next, the evaluation sample was placed on the display surface of the display device with its evaluation surface (transparent conductive layer side) facing upward. Thereafter, a green background was displayed on the display surface of the display device and, at this time, presence/absence of glare was evaluated by visual determination from immediately above the evaluation sample. Evaluations were performed with “◯” assigned when glare was absent and “x” assigned when glare was present. The results are shown in Table 1.

### (Minimum Value of Distances Between Two Non-Adjacent Sides of Opening of Black Matrix)

A minimum value of distances between two non-adjacent sides of the opening (i.e. length of the shorter side of the opening shown in FIG. 2) of the black matrix of the liquid crystal display device in the determination of glare described above was measured using a shape measurement laser microscope (manufactured by KEYENCE CORPORATION, trade name “VK-8500”, magnification: 10). The results are shown in Table 1.

### (Measurement of Maximum Diameter of Cross-Sectional Shape of Protrusion Portion)

A surface shape on the side of the transparent conductive layer as an outermost surface layer in the evaluation sample prepared in the determination of glare described above was measured in a visual field range of 92 μm×121 μm at a magnification of 50 using a non-contact type three-dimensional surface roughness meter (manufactured by Veeco Instruments Inc, trade name “WYKO NT3300”). The protrusion portion in the obtained surface shape data was cut into a round along a plane situated at a height of 10 nm above the flat portion, and a maximum diameter of the cross-sectional shape obtained at this time was measured. For the evaluation sample according to Example 4, measurements were performed for both surfaces (transparent conductive layer surface and cured resin layer surface). The results are shown in Table 1.

### (Haze)

A haze of the prepared transparent conductive film was measured using a haze meter (manufactured by MURAKAMI COLOR RESEARCH LABORATORY Co., Ltd., Model “HM-150”) in accordance with Haze (Turbidity) in JIS K7136 (2000). The results are shown in Table 1.

### (Blocking Resistance)

For the prepared transparent conductive film, a film having a smooth surface (manufactured by ZEON CORPORATION, trade name “ZEONOR Film ZF-16”) was pressure-bonded by finger pressure, a sticking state of the films at this time was visually checked (the number of specimens N=10). The results are shown in Table 1.

<Evaluation Criteria>

◯: No sticking

Δ: Films temporarily stick together, but leave each other with elapse of time

x: Sticking films no longer return to the original state

TABLE 1

| | | Thickness | Maximum | | | Glare (definition/ | | |
|---|---|---|---|---|---|---|---|---|
| | | (μm) of base | diameter (μm) | | | distance between | | |
| | Particle | flat portion | of cross-sectional | | | two sides of opening) | | |
| | size | of cured resin | shape of pro- | | Blocking | 324 ppi | 245 ppi | 170 ppi |
| | (μm) | layer | trusion portion | Haze | resistance | 22 μm | 28 μm | 44 μm |
| Example 1 | 3 | 1 | 29.4 | 0.6 | ∘ | x | x | ∘ |
| Example 2 | 2.5 | 1 | 30.9 | 1.2 | ∘ | x | x | ∘ |
| Example 3 | 1.8 | 1 | 16.6 | 1.8 | ∘ | ∘ | ∘ | ∘ |
| Example 4 | 1.8 | 1 | 16.6/16.6* | 2.7 | ∘ | ∘ | ∘ | ∘ |
| Example 5 | 2 | 1 | 10.1 | 1.1 | ∘ | ∘ | ∘ | ∘ |
| Example 6 | 1.5 | 1 | 4.8 | 1 | ∘ | ∘ | ∘ | ∘ |
| Example 7 | 1.3 | 1 | 4.6 | 1.4 | ∘ | ∘ | ∘ | ∘ |
| Example 8 | 3.5 | 2 | 12.3 | 1.4 | ∘ | ∘ | ∘ | ∘ |
| Comparative | 5 | 1 | 52.3 | 0.8 | ∘ | x | x | x |
| Example 1 | | | | | | | | |

*left: transparent conductive layer surface on the side of one surface/right: cured resin layer surface on the side of the other surface

For the transparent conductive films obtained in Examples, blocking resistance was good, and glare was suppressed even when combined with a high-definition liquid crystal display element of more than 150 ppi. Also, they were excellent in transparency with the haze being 3 or less for all samples. On the other hand, for the transparent conductive film obtained in Comparative Example, good results for blocking resistance and the haze were shown, but glare was caused when combined with a high-definition liquid crystal display element, and therefore, it was concluded that the transparent conductive film could not cope with a high-definition display element.

As described above, in the transparent conductive films of Examples 1 and 2, glare was suppressed even in a high-definition liquid crystal display element of more than 150 ppi, and it was found that the transparent conductive films of Examples 3 to 7 could cope with a further high-definition liquid crystal display element of up to 324 ppi. Therefore, it can be understood that it becomes possible to cope with a higher-definition display element as the maximum diameter at or near the foot of the protrusion portion in the outermost surface layer is made smaller depending on miniaturization of the opening of the black matrix.

What is claimed is:

1. A transparent conductive film for a display element which includes a black matrix having a polygonal opening and has a definition of 150 ppi or more, comprising:
a transparent polymer base material;
a transparent conductive layer provided on a first main surface side of the transparent polymer base material; and
a cured resin layer provided at least one of: between the transparent polymer base material and the transparent conductive layer; and on a second main surface opposite to the first main surface of the transparent polymer base material,
wherein a surface of an outermost surface layer on a side where the cured resin layer is formed has a flat portion and a protrusion portion,
a height of the protrusion portion is larger than 10 nm above the flat portion, and
a maximum diameter of a cross-sectional shape formed by intersection of a surface parallel to the flat portion and the protrusion portion at a distance of 10 nm from the flat portion is smaller than a minimum value of distances between two non-adjacent sides of the opening of the black matrix.

2. The transparent conductive film according to claim 1, wherein the cured resin layer has a base flat portion and a base protrusion portion on the surface, and
the flat portion of the outermost surface layer results from the base flat portion, and the protrusion portion results from the base protrusion portion.

3. The transparent conductive film according to claim 2, wherein the cured resin layer contains particles, and
the base protrusion portion is formed resulting from the particles.

4. The transparent conductive film according to claim 3, wherein a thickness of the base flat portion of the cured resin layer is smaller than a mode diameter of the particles.

5. The transparent conductive film according to claim 1, wherein the cured resin layer is provided between the transparent polymer base material and the transparent conductive layer, and
a refractive index adjusting layer is further provided between the cured resin layer and the transparent conductive layer.

6. The transparent conductive film according to claim 1, wherein a haze is 5% or less.

7. The transparent conductive film according to claim 1, further comprising a transparent conductive layer provided on the second main surface side opposite to the first main surface side of the transparent polymer base material.

8. A transparent conductive film wound body formed by winding a long sheet of the transparent conductive film according to claim 1 in a roll shape.

9. A touch panel comprising the transparent conductive film according to claim 1.

10. A display element comprising the transparent conductive film according to claim 1 and having a definition of 150 ppi or more.

11. An image display device, wherein a display element having a definition of 150 ppi or more and the touch panel according to claim 9 are laminated.
